(19) United States
(12) Patent Application Publication
(10) Pub. No.: US 2014/0265322 A1
(43) Pub. Date: Sep. 18, 2014

(54) CONDUIT COUPLER WITH COLLAR

(71) Applicant: Steven L. Thompson, Girard, KS (US)

(72) Inventor: Steven L. Thompson, Girard, KS (US)

(21) Appl. No.: 14/213,551

(22) Filed: Mar. 14, 2014

Related U.S. Application Data
(60) Provisional application No. 61/788,777, filed on Mar. 15, 2013.

(51) Int. Cl. F16L 37/04

(52) U.S. Cl. CPC F16L 37/04
USPC 285/345

(57) ABSTRACT

A conduit coupler system that employs a collar to prevent deformation of the coupler when compressed air is used to feed cable through the conduit ducts. The coupler includes a number of separate ducts and an end-seal which allows two sections of conduit to be joined together. The coupler utilizes a number of ribs to join adjacent conduit sections together.

### CROSS-REFERENCE TO RELATED APPLICATION

This application claims priority in U.S. Provisional Patent Application No. 61/788,777 filed Mar. 15, 2013, which is incorporated herein by reference.

### BACKGROUND OF THE INVENTION

1. Field of the Invention

The present invention relates generally to conduit systems, and more specifically to multiple duct conduit systems for fiber-optic cables often used alongside bridges and other spans.

2. Description of the Related Art

The present invention is designed to improve conduit connections for use with long-spanning conduit including multiple ducts for use with fiber-optic or other similar cable types. The typical use of long-span conduits is alongside bridges; however, long-span conduit can be used in any number of situations where conduit is desired.

Previous iterations of multi-duct long-span conduit have addressed means for joining conduit pieces together end-to-end; however, the most common approaches are not without their own issues. Some coupler means employ metal cleats which grip the internal face of the outer shell of a conduit. These couplers work, but can be difficult to install or to adjust, and can actually damage the conduit.

A typical long-span conduit coupler is introduced in U.S. Pat. No. 4,865,354, which is incorporated herein by reference. The typical coupler employs a rubberlike material connecting end which seals the interior of the conduit ducts while providing multiple spaced gripping members to prevent the ducts from coming apart.

The problem resides in the installation of the fiber-optic cables themselves. Cables are typically fed through the conduit using compressed air bursts. This compressed air can cause the rubber connection ends of the conduit coupler to inflate, thereby deforming the internal chambers where the cable should be fed through. When this occurs, the ducts may become unaligned or the fiber-optic cable can get hung up on a deformed edge of the duct.

What is needed is a coupler capable of preventing deformation at the most important section of the conduit duct. Heretofore there has not been available a conduit coupler system with the advantages and features of the present invention.

### SUMMARY OF THE INVENTION

The present invention is a conduit coupler system that employs a collar to prevent deformation of the coupler when compressed air is used to feed cable through the conduit ducts. The coupler includes a number of separate ducts and an end-seal which allows two sections of conduit to be joined together.

A typical conduit is used to span long distances. As such, the conduit coupler section must be capable of both sealing the conduit and internal ducts from moisture and debris, while ensuring that the conduit remains joined together. At the same time, due to the length in the conduit sections, the coupler must allow adjustment of the conduit if the internal ducts become misaligned. The primary purpose of the present invention is to prevent deformation of the coupler when compressed air forces cable through the internal ducts.

### BRIEF DESCRIPTION OF THE DRAWINGS

The drawings constitute a part of this specification and include exemplary embodiments of the present invention illustrating various objects and features thereof

FIG. 1 is an isometric view of an embodiment of the present invention.

FIG. 2 is a side sectional view demonstrating the interconnection of two long-span conduits using a conduit coupler.

FIG. 3 is a side sectional view of the same, showing the internal duct portions receiving a blast of compressed air.

FIG. 4 is a side sectional view of the same, showing the deformation of the coupler portion from the blast of compressed air.

FIG. 5 is a side sectional view demonstrating the interconnection of two long-span conduits using a conduit coupler fitted with a collar preventing deformation from a blast of compressed air.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

### II. Preferred Embodiment or Aspect Conduit Coupler System 2

Referring to the drawings in more detail; the numeral 2 generally refers to a conduit coupler system capable of joining a first long span conduit 16 and a second long span conduit 18, each conduit containing multiple internal ducts 12. The coupler 6 includes a gripping end 8 generally comprised of a rubber or similar type material capable of gripping the internal face of the second conduit 18.

As shown in FIGS. 1 and 2, the coupler gripping end 8 includes a number of semi-flexible ridges 10 which act to grip and seal the conduit connection. Each conduit 16, 18 includes a main shaft and first end of diameter D1 and a second end of diameter D2, split by a tapered portion 17. Diameter D2 is larger than diameter D1, such that the first end of the second conduit 18 fits into the second end of the first conduit 16. A spacer 14 may be used to keep the internal ducts 12 spaced properly for receiving adjacent conduit.

As shown in FIG. 3, once the coupler 6 has joined the two conduit sections 16, 18, a blast of compressed air 22 is used to feed fiber-optic cable or other cabling through the internal ducts 12. Further as shown in FIG. 3, the ducts 12 terminate at an interior chamber 20 of the coupler 6. As shown in FIG. 4, this can lead to a deformation of the coupler gripping end 8 because it is typically made of a flexible, gripping material such as rubber. This deformation can cause the ducts 12 to become misaligned, and can make it very difficult to remove or adjust the conduit sections 16, 18.

As shown in FIG. 5, a simple collar 4 can be placed over the gripping end 8 of the coupler 6. This collar will then prevent the deformation of the coupler 6, allowing it to function as it is intended. The collar may be made out of rigid plastic or metal, but must ensure that the gripping end 8 of the coupler 6 does not deform.

It is to be understood that while certain embodiments and/or aspects of the invention have been shown and described, the invention is not limited thereto and encompasses various other embodiments and aspects.

Having thus described the disclosed subject matter, what is claimed as new and desired to be secured by Letters Patent is:

1. A conduit coupler comprising:
a coupler body comprising an outer wall for positioning inside an end portion of an outer cylindrical conduit of a first adjacent conduit section;
a plurality of gripper ribs extending radially outward from said outer wall for engagement with an inner wall of said outer cylindrical conduit;
said gripper ribs extending in a generally circumferential direction around said outer wall, said gripper ribs configured to permit flow of air past said gripper ribs during installation and removal of said coupler body from said outer cylindrical conduit;
a plurality of axially spaced duct supporting cylindrical chambers located within said coupler body, said chambers configured to align with a plurality of inner ducts contained within said adjacent conduit section; and
a collar placed around said outer wall and located adjacent to said plurality of gripper ribs.

2. The conduit coupler of claim 1, wherein each of said chambers have a sealing wiper rib extending circumferentially around a surface of each of said chambers for engaging an outer surface of each of said adjacent sections of said inner ducts whereby the space between said adjacent sections of each of said inner ducts is sealed to facilitate use of air pressure to blow rope or tape used to pull cables through said inner ducts.

3. The conduit coupler of claim 2, wherein said collar is configured to restrict expansion of said cylindrical chambers and said outer wall due to air pressure blown through said inner ducts.

4. The conduit coupler of claim 1, wherein said coupler body joins said first adjacent conduit section to a second adjacent conduit section by bridging a gap between said first and second adjacent conduit sections.

5. The conduit coupler of claim 1, wherein:
said gripper ribs comprise a plurality of sets of said gripper ribs spaced axially and circumferentially of said coupler body on said outer wall at each end of said conduit coupler body; and
wherein said collar is located between said plurality of sets of gripper ribs.

6. The conduit coupler of claim 1, wherein said collar is comprised of plastic.

7. The conduit coupler of claim 1, wherein said coupler body has an external, circumferentially extending outer stop rib located on said outer wall at a location generally midway between the ends of said coupler body for limiting the movement of said adjacent sections of said outer cylindrical conduit over said outer wall of said coupler body.

8. The conduit coupler of claim 7, wherein a first end portion of said adjacent section of said outer cylindrical conduit has a diameter greater than the outer diameter of the remainder of said outer cylindrical conduit providing a bell at said first end portion for extending over an inner end portion of an adjacent section of said outer cylindrical conduit.
